(19) United States
(12) Patent Application Publication
(10) Pub. No.: US 2004/0108624 A1
(43) Pub. Date: Jun. 10, 2004

(54) Process for manufacturing tiles or panels in concrete-based conglomerated material, advantageoulsy for floating floorings as well as tile or panel obtained by means of such process

(76) Inventor: Alcide Castelli, Asola (IT)

Correspondence Address: Greenberg Traurig, Suite 400E, 2450 Colorado Avenue, Santa Monica, CA, 90404, US

(21) Appl. No.: 10/467,516

(22) PCT Filed: Dec. 18, 2001
(86) PCT No.: PCT/IT01/00636

(51) Int. Cl. B28B 3/00

(52) U.S. Cl. 264/333

(57) ABSTRACT

A process for the production on an industrial scale of tiles or panels (10) made of a concrete-based agglomerated material, comprises the following steps:

crushing of the stone-like inert material;

preparing of a mixture made of water, crushed material, as well as cement binder inert sands;

preparing of a frame made of plastic material inside a pressing mould, inside which a reinforcing net of is placed;

dosing of said mixture inside the aforesaid mould;

pressing of the mixture in order to obtain a tile comprising a predetermined configuration together with pre-defined dimensions, said pressing being realized by means of a shaped holding-block for ashlars or punches, positioned in use above the mold, suitable for supporting a plurality of ashlars or punches penetrating in use said mixture through the meshes of said net;

extracting the tile from the mould and the following seasoning of the same tile.

### TECHNICAL FIELD

The present invention relates to a process for the production on industrial scale of tiles or panels for floating floorings and to a tile or panel for floating floorings.

More particularly, the present invention relates to a process to obtain tiles or panels in a material generally consisting of mixtures based on water, concrete, and powder and chips of stone-like material, particularly marble, stone or granite, with possible intrusions of various kinds, suitable for the laying of floating floorings.

According to another aspect, the present invention refers to a tile or panel made of a concrete-based conglomerated material obtained by means of such process.

The invention mainly applies to the field of the industrial processing of marbles, stones, granites and the like.

### BACKGROUND ART

A known process to obtain tiles or panels in concrete conglomerated material comprises:

a preparation phase of a mixture comprising water, high resistant concrete and a selection of stone-like crushed material in the form of powders or chips of various dimensions;

the dosing of such mixture inside a pressing mould;

the following pressing at high pressure to form a monolayered tile or panel;

the hardening of the tile or panel, generally through vapour seasoning;

the possible following operations of honing, polishing and chamfering.

By means of said process tiles or panels of concrete conglomerated material are obtained with accurate and predetermined dimensions.

As it can easily be understood, such tiles are made of an absolutely inactive material, both from a mechanical and an electrical points of view; besides, inside such material there is no synthetic resin since the function of binder is achieved by the cement.

As a consequence, unlike some of the solutions known in the art, the tiles in concrete-based conglomerated material are entirely fireproof, such to be classified in “class zero”

From the foregoing it derives that the tiles in concrete-based conglomerated material are particularly suitable, in virtue of their properties of electrostatic mechanical inactivity, and thanks to the fact that they are fireproof, for being used for laying of floating or added floorings, that normally comprise a reticular framework maintaining the panels raised from the ground to define a proper air space for the containment of electric cables and/or hydraulic pipelines.

Nevertheless, a remarkable drawback is constituted by the fact that the tiles of a floating flooring require a quite consistent thickness in order to withstand the loads of stamping that under these conditions are not supported by the ground, and under such conditions the tiles known in the art result as being particularly heavy, what results in remarkable difficulties of installation.

Besides, taking into account the remarkable quantity of material required to produce every single tile, they result in practice rather expensive.

### DESCRIPTION OF THE INVENTION

The present invention aims to provide a process for the production on industrial scale of tiles or panels for floating floorings able to eliminate or substantially reduce the above reported drawbacks.

Furthermore the present invention aims to provide a process that can be industrially carried ou in a relatively short period of time such to result economically favourable.

This is achieved by means of a process for the production on industrial scale of tiles or panels for floating floorings having the features described in the main claim.

According to another aspect, the present invention aims to provide a tile or panel for floating floorings comprising good mechanical characteristics together with a limited weight and a practically totally fireproof.

This is obtained through a tile or panel for floating floorings having the features described in claim 6.

The dependent claims describe advantageous embodiments of the invention.

The process for the production on industrial scale of tiles or panels for floating floorings according to the invention comprises the following working steps:

crushing of stone-like inert material;

preparing of a mixture made of water, crushed material, as well as cement binder inactive sands;

preparing of a frame made of plastic material inside a pressing mould, inside which a reinforcing net of is placed;

dosing of said mixture inside the aforesaid mould;

pressing of the mixture in order to obtain a tile comprising a predetermined configuration together with pre-defined dimensions, said pressing being realized by means of a shaped holding-block for ashlars or punches, positioned in use above the mold, suitable for supporting a plurality of ashlars or punches penetrating in use said mixture through the meshes of said net;

extracting the tile from the mould and the following seasoning of the same tile.

According to particular forms of embodiment of the invention, the process can further include subsequent steps of polishing of the upper face of the tile, of cutting to size, of chamfering and calibrating said tile.

According to the invention inside the press, before dosing of the mixture, a frame is positioned that, once installe, defines the side edges of the tile, said frame being suitable for supporting the reinforcing net.

Such frame, after the phase of pressing, becomes a single body with the tile; in this way the final product differs from the already known solutions, where such protection frame of is added in a second time by glueing.

The frame can be made in composite plastic material that stands quite high temperatures.

The process is realized by means of automatic control machines for the phases of both manufacture and the transfer of the material being processed from a machine to the other, and governed by a suitable electronics that controls the whole production cycle of the tiles or panels.

The tile or panel, for floating floorings, according to the invention, is made of conglomerated inert material with an embedded metallic reinforcing or supporting net, whereby its lower surface comprises a plurality of cavities corresponding to the meshes of said net.

The cavities, which can have a depth corresponding to a major part of the tile thickness, guarantee a considerable reduction of the weight of the panel without penalizing the characteristics of mechanical resistance assured by the presence of the metallic reinforcement.

The tile thickness comprises, close to the base surface, an external flaring suitable for enabling an easy laying of the floating flooring, by inserting each panel onto a suitable framework raised from the ground. In such a way the tile is inserted in the framework without the need of any other operation for its own laying.

### ILLUSTRATION OF DRAWINGS

Other features and advantages of the invention will become evident on reading the following description of one form of embodiment of the invention, given as a non-binding example, with the help of the attached drawings, in which:

FIG. 1 shows a perspective view, slightly from above, of a tile according to the invention;

the FIG. 2 illustrates a plan view from below of the tile according to the invention;

the FIG. 3 is a front view of the tile according to the invention, in which some inner details of the same tile are highlighted.

### DESCRIPTION OF A FORM OF EMBODIMENT

In the figures, reference number 10 generally indicates a tile or panel obtained through the process according to the present invention, in this case a tile 10 made of inert concrete-based agglomerated material.

The panel 10 can be made of a mixture of cement, powder of marble or other stone-like material in form of chips of different dimensions and nature, which a suitable colouring agent can eventually be added to.

The process for the production on industrial scale of tiles or panels 10 according to the invention comprises the following steps:

crushing of the stone-like inert material;

preparing of a mixture made of water, crushed material, as well as cement binder inert sands;

preparing of a frame made of plastic material inside a pressing mould, inside which a reinforcing net of is placed;

dosing of said mixture inside the aforesaid mould;

pressing of the mixture in order to obtain a tile comprising a predetermined configuration together with pre-defined dimensions, said pressing being realized by means of a shaped holding-block for ashlars or punches, positioned in use above the mold, suitable for supporting a plurality of ashlars or punches penetrating in use said mixture through the meshes of said net;

extracting the tile from the mould and the following seasoning of the same tile.

According to the invention, prior to the pouring of the mixture of crushed material, a frame 11, suitable for supporting the reinforcing net 12, is positioned inside the moulding matrix of the press,.

The frame 11 is positioned on the base of the mould and is internally provided with a series of supports 14 suitable for supporting the respective ends of the metallic rods forming the net 12 which, in operation, is inserted in a central portion relative to the thickness of the panel 10 (see FIG. 3).

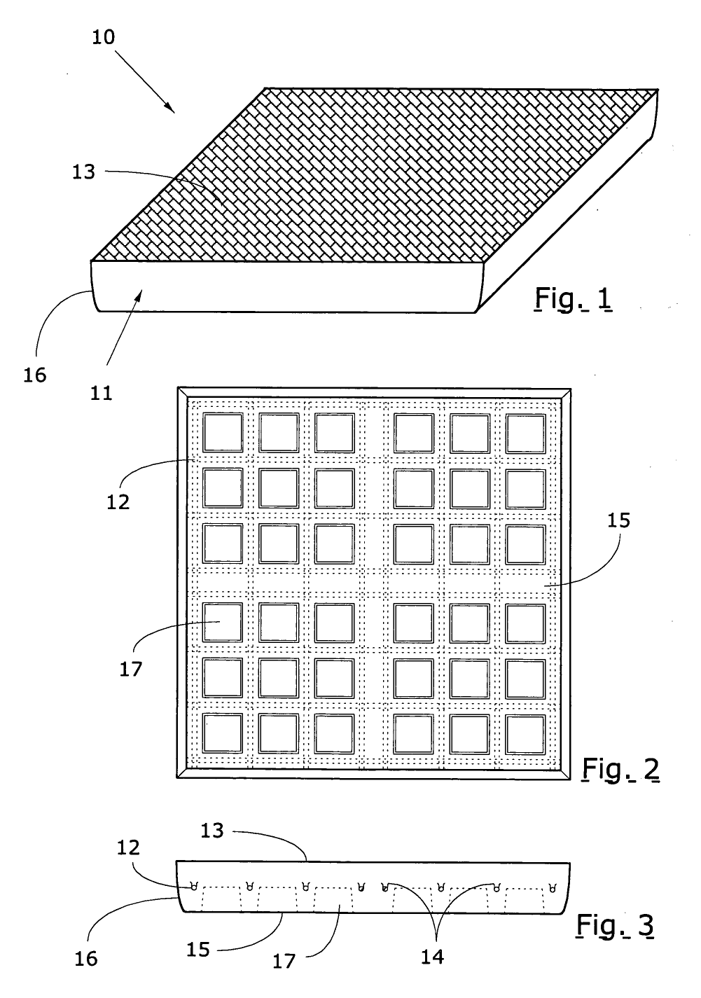

Referring first to FIGS. 1 and 3, it can be noticed that a tile 10 advantageously has a configuration with a slightly prismatic quadrangular base having a lower surface 15 and an upper surface 13, the latter being laid at sight.

Each side of the tile 10 comprises, close to the lower surface 15, an external flaring 16 suitable for enabling an easy laying operation of the same tile 10 on the special framework of an elevated flooring (not shown in the drawings).

As it can be seen in FIG. 2, the lower surface 15 of the tile 10 comprises a plurality of cavities 17 suitable for conferring to the tile a relatively reduced weight. Every cavity 17 is bordered by a respective mesh made from the metallic rods of the reinforcing net 12.

The cavities 17, which can have a depth corresponding to a major part of the thickness of the tile 10, guarantee a considerable reduction of the weight of the tile 10 without penalizing the characteristics of mechanical resistance assured by the presence of the metallic reinforcement 12.

From laboratory tests, a panel of dimensions 60×60 centimetres with a thickness of 3,4 centimetres shows a minimal breaking load equal to 6300 Newtons.

The frame 14 can be made of a composite plastic. material resistant to relatively high temperature or of a metallic alloy.

The inert materials and the total absence of resins make the panel 10 as almost fireproof and “class 0” with reference to the fire prevention rules. Moreover such materials assure an elevated resistance to the low temperatures making the tile resistant to frost.

The invention has previously been described with reference to an advantageous form of embodiment of the same.

Nevertheless, it is clear that the invention is susceptible of numerous variants, in the field of the technical equivalences.

1. Process for the production on an industrial scale of tiles or panels (10) made of a concrete-based agglomerated material, characterized in that it comprises the following steps:
crushing of the stone-like inert material;
preparing of a mixture made of water, crushed material, as well as cement binder inert sands;
preparing of a frame made of plastic material inside a pressing mould, inside which a reinforcing net of is placed;
dosing of said mixture inside the aforesaid mould;
pressing of the mixture in order to obtain a tile comprising a predetermined configuration together with pre-defined dimensions, said pressing being realized by means of a shaped holding-block for ashlars or punches, positioned in use above the mold, suitable for supporting a plurality of ashlars or punches penetrating in use said mixture through the meshes of said net;
extracting the tile from the mould and the following seasoning of the same tile.

2. Process according to claim 1, characterized in that said frame (11) is made of a composite plastic material standing to relatively elevated temperature.

3. Process according to any of the preceding claims, characterized in that, as a consequence to the pressing step, said frame (11) forms a single body with said tile (10).

4. Process according to any of the preceding claims, characterized in that it is carried out by means of automatic control machines for the phases of both manufacturing and transferring the material being processed from a machine to another one.

5. Tile or panel (10) made of a concrete-based conglomerated material formed by a mixture of water with stone-like material in powder or chips and cement sands, characterised in that it is provided with a side frame (11) acting as means of support for a reinforcing net (12) placed inside said tile.

6. Tile (10) according to claim 5, characterized in that its base surface (15), comprises plurality of cavities (17).

7. Tile (10) according to claim 6, characterized in that the meshes (18) of the net (12) are bordered by said respective cavities (17).

8. Tile (10) according to any of the claims from 5 to 7, characterized in that each side comprises, close to the base surface (15), an external flaring (16).

9. Tile (10) according to any of the claim from 5 to 8, characterized in that it is manufactured by means of a process according to any of the claims from 1 to 4.
